(19) United States
(12) Patent Application Publication
(10) Pub. No.: US 2005/0044186 A1
(43) Pub. Date: Feb. 24, 2005

(54) Remote interface optical network

(76) Inventor: Gregory C. Petrisor, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/867,384

(22) Filed: Jun. 14, 2004

Related U.S. Application Data
(60) Provisional application No. 60/478,732, filed on Jun. 13, 2003.

(51) Int. Cl. G06F 15/16

(52) U.S. Cl. 709/219

(57) ABSTRACT

A remote interface network in which multiple remote HID encoder/decoder units share a common physical transport medium for connecting to one or more processing unit encoder/decoders is described. In one embodiment, the physical transport medium includes an optical shared media transport network. Each remote HID encoder/decoder unit can support one or more remote HIDs. The processing unit encoder/decoder can support one or more Pus. The network can be used, for example, in office, hospital, dense seat (e.g., aircraft, bus, etc.) and content provider networks.

### REFERENCE TO RELATED APPLICATION

The present application claims priority benefit of U.S. Provisional Application No. 60/478,732, filed Jun. 13, 2003, “REMOTE INTERFACE OPTICAL NETWORKS,” the entire contents of which is hereby incorporated by reference.

### BACKGROUND

1. Field of the Invention

The present disclosure relates to computer network systems.

2. Description of the Related Art

Optical transport networks are in use or have been proposed for a number of network classes. These include backbone networks, metro core networks, metro access networks, and local access or “last mile” networks. The move to optical transport networks has been in response to the demand for increased network capacity. The key drivers that have led to this demand include the continued growth of Internet traffic, the emergence of residential broadband services market, and the emerging mobile Internet market. Several “all optical” networks have been proposed to service various classes of these networks. For example, various versions of the Passive Optical Networks (PON) have been proposed for the “last mile” portion of the network. And several “all optical” solutions have been proposed for the metro access network (MAN), see, e.g., I. M. White, “A new architecture and technologies for high-capacity next generation metropolitan networks,” Ph.D. dissertation (Department of Electrical Engineering, Stanford University, Stanford, Calif., August 2002; Ian M. Whiate, Mathew S. Rogge, Kapil Shrikhande, and Leonid G. Kazovksy, “Design of a control-channel-based media-access-control protocol for HORNET”, Journal of Optical Networking, Vol. 1, No. 12, December 2002; A. Carena, V. Ferrero, R. Gaudino, V. De Feo, F. Neri, P. Poggiolini “Ringo: a Demonstrator of WDM Optical Packet Network on a Ring Topology”, Optical Network Design and Modeling Technical Program, 2002, with one of the most prominent “all optical” MAN solutions being the Hybrid Optical Electronic Ring Network (HORNET). The HORNET uses an all optical data layer and an optoelectronic control layer. Most of them rely on fiber as the underlying physical transport medium.

Optical networks have also been proposed for “in the box” networks. These networks include various flavors of all optical backplanes. For example, a WDMA passive optical backplane bus is proposed in V. E. Bros, A. D. Radik, and S. Parameswaren, “High-level Model of a WDMA Passive Optical Bus for a Reconfigurable Multiprocessor System” 37^{th} Design Automation Conference, Jun. 5-9, 2002, Los Angeles, Calif.

Whereas there have been a number of all optical networks proposed for data transport networks and “in the box” networks, all optical networks are not known to have been proposed for remote interfacing. Remote interface networks are, generally speaking, networks that connect interface devices to remote processing units they support. A simple example of remote interface networks are networks which connect human interface devices such as keyboards, displays, and computer mice to a remote personal computer. A common example of a remote interface network is a KVM network.

The first KVM networks were developed over 20 years ago. In the early 1980's, as the computer industry grew, many server rooms and data centers were faced with the problem of having dozens and even hundreds of monitors, keyboards, and mice, taking up valuable rack space, and adding unnecessary heat disbursement issues. They also created server management problems for larger data centers in which technicians had to physically walk to each server they needed to work on.

The first KVM products to address these issues were single-user KVM switches. These switches enabled a single user to access multiple remote CPUs from a single monitor, keyboard, and mouse. In addition to improving server manageability, heat disbursement issues, and the space savings, there was a huge cost savings from not having to purchase a separate monitor, keyboard and mouse for each CPU. These single user KVM switches are still widely used and can be found in almost every data center. However, handling large amount of servers with these KVM switches is cumbersome at best, and impractical if more than one user requires simultaneous access.

To address this need, the KVM industry developed KVM switches geared to being enterprise wide solutions, which allow data center managers to set up a NOC or control room where their technical people can remotely access any or all of the servers/devices in their server farms. In addition to no longer having to walk and locate a server you need to work on, these system deployed advanced security features that allow managers to restrict unnecessary physical access to sensitive equipment.

Known KVM systems are all electronic except for optional optical KVM extenders which convert the electronic KVM signals to optical signals for transport across large distances. These optical KVM extenders implement point-to-point links and serve only to extend the reach of KVM cables.

The KVM industry provides systems that are primarily focused on the management of large computing systems such as server farms etc. that generally run applications that are accessed by end users remotely through the data network such as Web applications, database applications, large scientific/business applications, etc. The only KVM type products that are known in the office setting are the single-user variety used to manage multiple local PCs from the same keyboard-video-mouse set.

In the office environment, there are a number of concerns raised by placing the computing system and the human interface in such close proximity in the workplace. These include security, as a rogue employee can gain access to critical information on a distributed computer's hard drive; the introduction of illegal, inappropriate or dangerous software onto the computing system; damage due to an unauthorized employee attempting to repair systems; logistics of distributed support; damage due to the inability to locate the processing unit in an appropriate location within the office environment; additional heat generated by the processing units overwhelming and damaging the air conditioning system; and, the noise pollution from the local processing unit reducing the productivity of an employee.

Attempts have been made to physically separate the processing units from the human interfaces, specifically, by keeping the human interfaces (e.g. monitor, keyboard, mouse and printer) at a workstation while relocating the chassis holding the motherboard, power supply, memory, drives, etc. to a secured computer room. There are several key aspects of these systems that differ from a typical KVM system. First, a typical PC user has become accustomed to many more human interface devices then just the keyboard, video, and mouse. At one's desktop, in addition to the keyboard monitor and mouse you may also find a local printer, a local scanner, a Web cam, a USB port, a microphone, a head-set, etc. Second, the system must typically support longer distances than KVM systems (control room near data center vs. distributed offices around a campus). Third, the switching function is less critical than the remoting function. Systems that service this market are referred to as KVM+ systems in this application.

One approach to physically separating the HIDs from the processing unit in a non-switched system (implementing a basic KVM+ system) is to use longer cables. However, this is not practical as it leads to large, expensive, unwieldy cable assemblies with significant limitations on the maximum distance between the HIDs and the PUs. To address these issues, KVM+ systems generally use encoding techniques to multiplex disparate native device signals into a manageable number of robust transport form signals, see, e.g., U.S. Pat. No. 6,385,666 “Computer system having remotely located I/O devices where signals are encoded at the computer system through two encoders and decoded at the I/O devices through two decoders,” U.S. Pat. No. 6,421,393 “Technique to transfer multiple data streams over a wire or wireless medium,” and U.S. Pat. No. 6,426,970 “Bi-directional signal coupler method and apparatus,” that can be transported longer distances on manageable cable assemblies such as CAT-5 cable and fiber.

The KVM+ systems require a point-to-point connection between each remote HID encoder/decoder and the processing unit encoder/decoder. In many applications this is not a problem as long as the point-to-point cable assembly is easy to install and not expensive. However, in some applications the star wiring from the processing unit encoder/decoder unit to the HID encoder/decoder units is not practical. For example, applications that cannot support large groupings of cable assemblies that generally occur near the processing unit encoder/decoder and along common cabling paths, as well as applications in which the cable assemblies implementing the point-to-point connections cannot be implemented as one monolithic cable but are formed by connecting multiple cable segments.

### SUMMARY

These and other problems are solved by a remote interface network in which multiple remote HID encoder/decoder units share a common physical transport medium for connecting to one or more processing unit encoder/decoders. In one embodiment, the physical transport medium includes an optical shared media transport network. Each remote HID encoder/decoder unit can support one or more remote HIDs. The processing unit encoder/decoder can support one or more Pus. The network can be used, for example, in office, hospital, dense seat (e.g., aircraft, bus, etc.) and content provider networks.

In one embodiment, a remote interface network provides multiple remote human interface device encoder/decoder units that can share a common physical transport medium for connecting to one or more processing unit encoder/decoders. Each remote encoder/decoder unit can support one or more remote devices some of which can be human interface devices. The processing unit encoder/decoder can support one or more processor units.

In one embodiment, an HID network provides one or more remote stations having a set of interface devices associated with a user and a station encoder/decoder. A digital transport network is provided to connect to one or more content sources (PUs) through a crossbar switch. The encoders convert native format signals into one or more serial bit streams for transport over the digital transport network. The decoders convert one or more serial bitstreams into native format signals to drive native devices. The crossbar can be configured to broadcast one processing unit channel to multiple stations, to multi-cast one processing unit channel to multiple stations, to form a point to point connection between one processing unit and one station, or a combination of multicast and point to point connections. The control of the crossbar can be external, from control signals extracted from the station's serial bit streams as they enter the cross bar, or from control signals from the processor units.

In one embodiment, a remote device interface network, includes a first processing unit configured to provide at least a first raw video output signal for a first video display, a second processing unit configured to provide at least a second raw video output signal for a second video display, a first processor-side encoder/decoder configured to convert the first raw video output signal into a first serial digital sampled data stream, a second processor-side encoder/decoder configured to convert the second raw video output signal into a second serial digital sampled data stream, a first HID-side encoder/decoder configured to convert the first serial digital sampled data stream into a representation of the first raw video output signal, a second HID-side encoder/decoder configured to convert the second serial digital sampled data stream into a representation of the second raw video output signal and to convert signals from an output signal from a human interface device into a third serial digital sampled data stream, and a shared-media transport layer configured to provide bi-directional communication between the first and second processor-side encoder/decoders and the first and second HID-side encoder/decoders by transporting the first and second serial digital sampled data streams in a downstream direction and transporting the third serial digital sampled data stream in an upstream direction. In one embodiment, the shared-media transport layer includes a fiberoptic system. In one embodiment, the shared-media transport layer includes single-mode fiber. In one embodiment, the transport layer includes coaxial cable. In one embodiment, the transport layer includes twisted-pair cable. In one embodiment, the first raw video output signal includes a VGA video signal. In one embodiment, the first raw video output signal includes an NTSC video signal. In one embodiment, the first raw video output signal includes a PAL video signal. In one embodiment, the first raw video output signal includes a digital television signal. In one embodiment, the first raw video output signal includes a composite video signal. In one embodiment, the first raw video output signal includes an S-video signal. In one embodiment, the first raw video output signal includes a RGBY video signal. In one embodiment, the first raw video output signal includes an uncompressed video signal. In one embodiment, the first raw video output signal includes a Digital Video Interface (DVI) video signal. In one embodiment, the first raw video output signal includes a DVI-analog video signal. In one embodiment, The remote device interface network of claim 1, wherein the first raw video output signal includes a DVI-digital video signal. In one embodiment, the first raw video output signal includes a Low Voltage Differential Interface (LVDS) video signal. In one embodiment, the output signal from a human interface device includes a USB signal. In one embodiment, the output signal from a human interface device includes an Ethernet-compatible waveform. In one embodiment, the output signal from a human interface device includes a firewire compatible waveform. In one embodiment, the output signal from a human interface device includes a standard serial computer mouse signal. In one embodiment, the output signal from a human interface device includes a standard personal computer keyboard signal. In one embodiment, the output signal from a human interface device includes a game controller signal. In one embodiment, the transport network includes a crossbar configured to provide bi-directional communication between M processor-side encoder/decoders and N HID-side encoder/decoders. In one embodiment, a latency delay between an input of the first processor-side encoder/decoder and an output of the first HID-side encoder/decoder is less than five video frames of the first raw video signal. In one embodiment, a latency delay between an input of the first processor-side encoder/decoder and an output of the first HID-side encoder/decoder is less than two video frames of the first raw video signal.

In one embodiment, a remote device interface network, includes a first processing unit configured to provide at least a first native video output signal for a first video display, a second processing unit configured to provide at least a second native video output signal for a second video display, a first processor-side encoder/decoder configured to convert the first native video output signal into a first serial digital sampled data stream, a second processor-side encoder/decoder configured to convert the second native video output signal into a second serial digital sampled data stream, a first HID-side encoder/decoder configured to convert the first serial digital sampled data stream into a representation of the first native video output signal, a second HID-side encoder/decoder configured to convert the second serial digital sampled data stream into a representation of the second native video output signal and to convert signals from an output signal from a human interface device into a third serial digital sampled data stream, and a shared-media transport layer configured to provide bi-directional communication between the first and second processor-side encoder/decoders and the first and second HID-side encoder/decoders by transporting the first and second serial digital sampled data streams in a downstream direction and transporting the third serial digital sampled data stream in an upstream direction. In one embodiment, the transport layer includes a fiberoptic system. In one embodiment, the transport layer includes single-mode fiber. In one embodiment, the transport layer includes coaxial cable. In one embodiment, the transport layer includes twisted-pair cable. In one embodiment, the first native video output signal includes a VGA video signal. In one embodiment, the first native video output signal includes an NTSC video signal. In one embodiment, the first native video output signal includes a PAL video signal. In one embodiment, the first native video output signal includes a digital television signal. In one embodiment, the first native video output signal includes a composite video signal. In one embodiment, the first native video output signal includes an S-video signal. In one embodiment, the first native video output signal includes a RGBY video signal. In one embodiment, the first native video output signal includes an uncompressed video signal. In one embodiment, the first native video output signal includes a Digital Video Interface (DVI) video signal. In one embodiment, the first native video output signal includes a DVI-analog video signal. In one embodiment, The remote device interface network of claim 1, wherein the first native video output signal includes a DVI-digital video signal. In one embodiment, the first native video output signal includes a Low Voltage Differential Interface (LVDS) video signal. In one embodiment, the output signal from a human interface device includes a USB signal. In one embodiment, the output signal from a human interface device includes an Ethernet-compatible waveform. In one embodiment, the output signal from a human interface device includes a firewire compatible waveform. In one embodiment, the output signal from a human interface device includes a standard serial computer mouse signal. In one embodiment, the output signal from a human interface device includes a standard personal computer keyboard signal. In one embodiment, the output signal from a human interface device includes a game controller signal. In one embodiment, the transport network includes a crossbar configured to provide bi-directional communication between M processor-side encoder/decoders and N HID-side encoder/decoders. In one embodiment, a latency delay between an input of the first processor-side encoder/decoder and an output of the first HID-side encoder/decoder is less than five video frames of the first native video signal. In one embodiment, a latency delay between an input of the first processor-side encoder/decoder and an output of the first HID-side encoder/decoder is less than two video frames of the first native video signal.

### BRIEF DESCRIPTION OF THE DRAWINGS

FIG. 1 shows a KVM remote interface system.

FIG. 2 shows a distributed computing system.

FIG. 3 shows an enhanced KVM remote interface system.

FIG. 4 shows various categories of networks, including data transport networks, “in the box” networks, and remote interface networks.

FIG. 5 shows a network for connecting a plurality of HIDs to one or more processing units.

FIG. 6 shows a hybrid HID/electrical-optical interface device (HID/EOID) network.

FIG. 7 shows a crossbar network for connecting a plurality of HIDs to one or more processing units.

FIG. 8 shows one embodiment of an HID encoder/decoder for use in the remote device network.

FIG. 9 is a block diagram of one embodiment of the HID encoder/decoder of FIG. 8 for use in an optical network.

### DETAILED DESCRIPTION

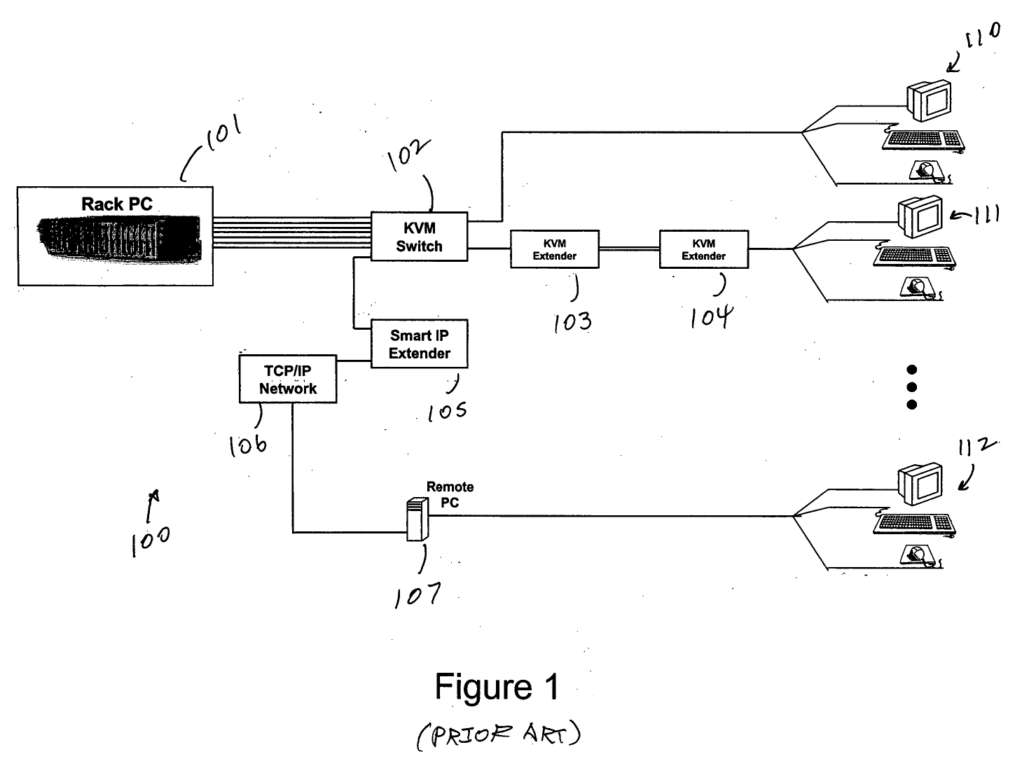

FIG. 1 shows an example of a KVM remote interface network 100. In the network 100, keyboard, video, and mouse interfaces on a racked PC 101 (or PCs) are provided via a “KVM cable” to a processor-side KVM interface on a KVM switch 102. To reduce the wiring complexity, most KVM component suppliers offer combined keyboard-video-mouse cables, called “KVM cables”, which break out the component cables at both ends. Multiple keyboard-monitor-mouse sets are typically attached to the device side of the KVM switch 102. In this example, a keyboard-monitor-mouse set 110 is provided to the KVM switch, a keyboard-monitor-mouse set 111 is provided to the KVM switch 102 through a KVM extender 103,104, and a keyboard-monitor-mouse set 111 is provided to the KVM switch 102 by TCP/IP by using a PC 107, TCP/IP network 106, and IP Extender 105. Typically, a defined key sequence on one or more of the keyboards in the keyboard-monitor-mouse set 110-111 allows a user to control the KVM switch 102.

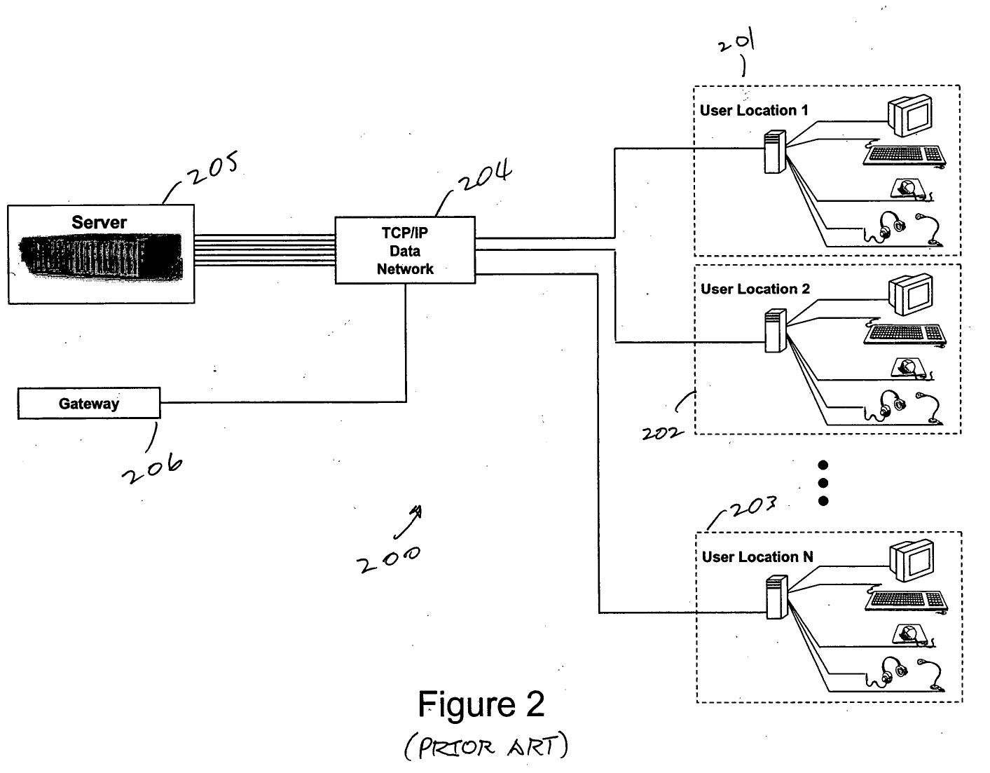

FIG. 2 shows a typical distributed computing system 200 where one or more user computers 201-203 communicate with a server 205 through a data network 204. The computing systems deployed most often in an office or home environment fall in the distributed system category. Peripheral devices such as, for example, keyboards, mice, monitors, etc. are provided to the user computers 201-203.

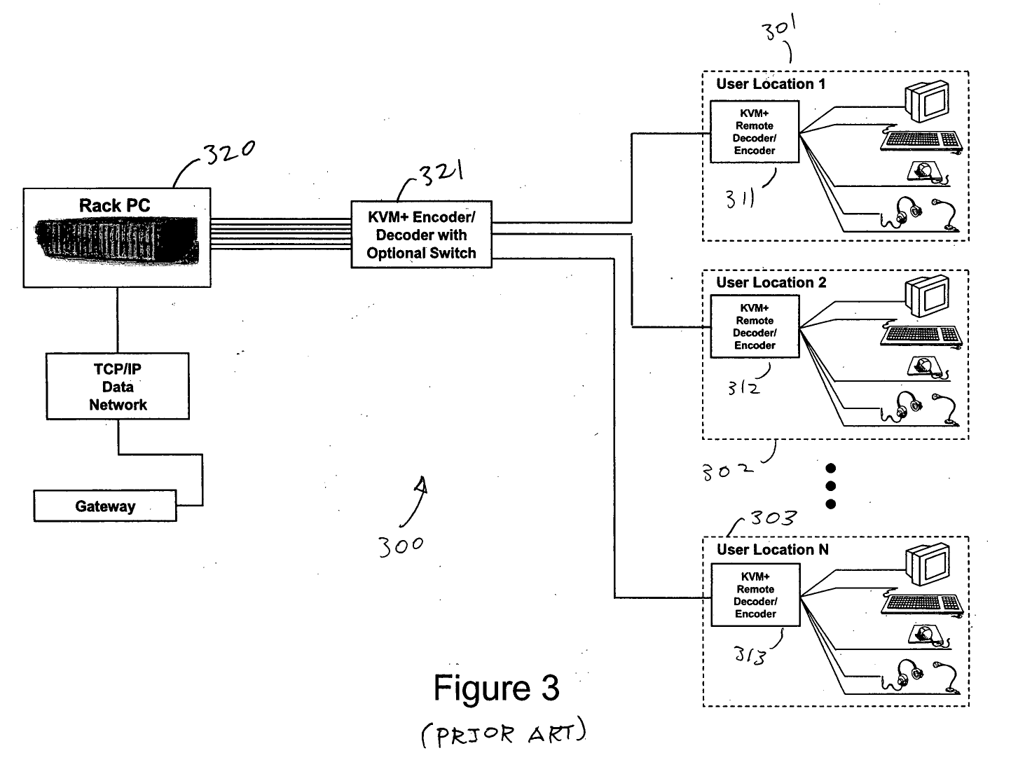

FIG. 3 shows a KVM+ system 300. The system 300 includes a number of user stations 301-303. An encoder/decoder 321 is provided to the KVM interfaces on a processing unit 320. Each user station 301-303 includes a remote KVM encoder/decoder that provides an interface to the KVMs in native form. Thus, for example the user station 301 includes a remote encoder/decoder 311 to interface to the KVMs at the user station 301. Cables (usually standard CAT-5 or fiber) connect the remote KVM encoder/decoders 311-313 to the processing unit encoder/decoder 321. For signals transmitted from the processing unit to an KVM at the user station 301, the processing unit encoder/decoder unit 321 combines sets of multiple KVM outbound signals in native form (one set for each PU) into sets of robust output signals (one set for each PU) and the remote KVM encoder/decoder 311 demultiplexes the processing unit to KVM transport signals into their native form to drive the KVM devices. For signals transported from the KVMs to the processing unit 320, the remote KVM encoder/decoder 311 combines multiple inbound KVM signals in native form into a set of transport form signals and the processing unit encoder/decoder 321 demultiplexed the transport form signals back into native form in order to connect to the processing unit 320.

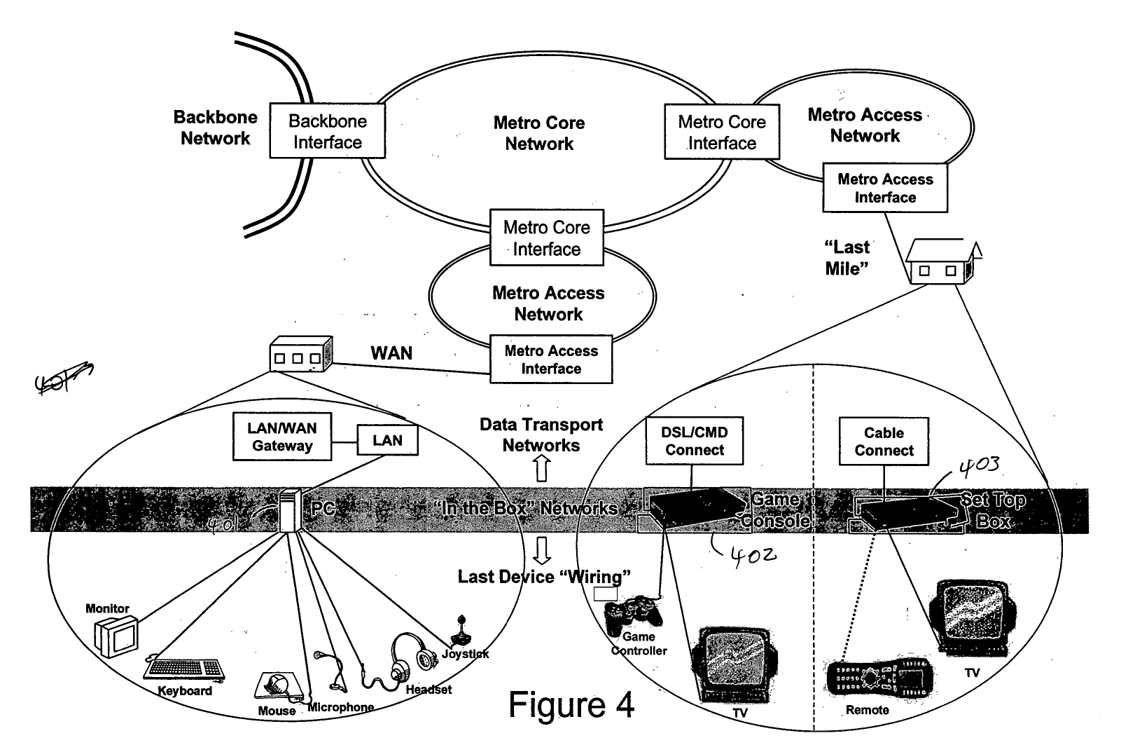

FIG. 4 shows three categories of networks. The first category includes data transport networks, such as, for example, telecom networks that include LAN, WAN, “last mile”, MAN, metro core networks, and backbone networks. A property shared by most networks in this category is that they are used to transport data between two processing units and generally this transport involves passing though in-path processing units (switches, routers, gateways, etc.). The second category includes “in the box” networks, which are networks that exist internal to the processing units and include such common networks as PCI and VME. The third category, is the remote interface or “last device” network. In FIG. 4, last device wiring is shown for a number of processing units including a PC 401, a game console 402, and a set-top box 403. The PC 401 is provided to various Human Interface Devices (HIDs), such as, for example, a monitor, a keyboard, a mouse, a microphone, a headset, and a joystick, a printer, etc. The game console 402 is wired to other HIDs including a TV and a game controller. The set-top box 403 is connected to a remote control via a wireless link and is wired to the TV.

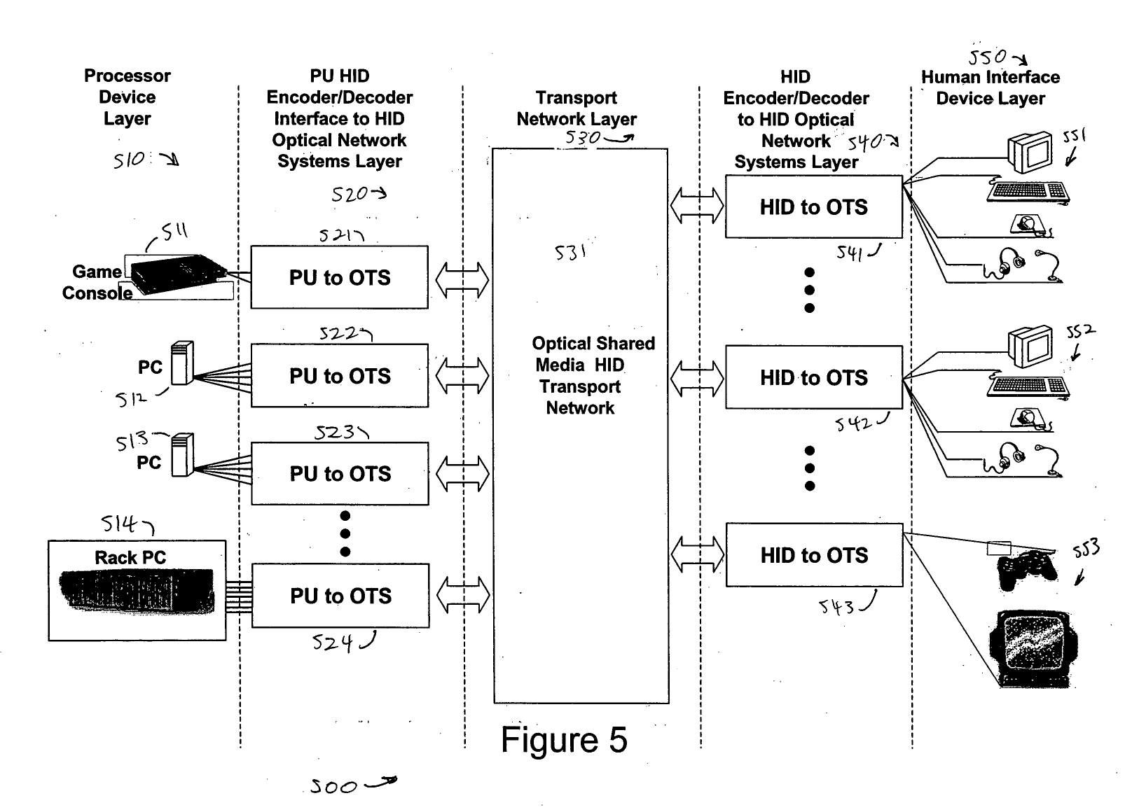

FIG. 5 shows an HID network 500 for connecting a plurality of processing units that can be either co-located (such as in a PC rack), or distributed, to a plurality of distributed groups of HIDs through an all optical shared media transport network in a transparent fashion. The HID network 500 includes a processor layer 510, a processing unit HID encoder/decoder layer 520, a shared-media transport layer 530, an HID encoder/decoder layer 540, and an HID layer 550. The processor layer 510 includes one or more processing units, such as, for example, a game console 511 streaming audio and/or video sources, video or audio on demand sources, communication devices (e.g., telephone devices), global position system devices, flight information devices, one or more computers 512-514, and/or any device that provides analog and/or digital data signal to an HID or that receives analog and/or digital signals. The computers 512-514 can be rack mount computers, servers, desktop computers, computer modules, etc.

The processing unit HID encoder/decoder layer 520 includes processing unit HID encoder/decoders 521-524. The processing unit HID encoder/decoder 521 is provided to encode/decode HID data and/or signals for the game console 511. The processing unit HID encoder/decoders 522-514 are provided to encode/decode HID data and/or signals for the computers 512-514, respectively. The transport layer 530 includes an optical shared network 531. The processing unit HID encoder/decoders 522-524 are provided to the optical shared network 531. The HID encoder/decoder layer 540 includes one or more HID encoders, such as, for example HID encoders 541-543. The HID encoders are provided to HID devices in the HID layer 550, such as, for example, HID groups 551-553. The HID groups 551-553 include one or more HID devices, such as, for example, keyboards, computer mice, video display units, game controllers, joysticks, microphones, speakers, keypads, printers, scanners, etc. In one embodiment, the processor-side encoder/decoders 522-524 accept native HID signals from the processors and/or provide native HID signals to the processors. Thus, for example, in one embodiment, the processor-side encoder/decoders 522-524 accept raw video signals from the processors and convert the raw video signals into serial bitstreams for the transport layer 531. The raw video signals can include, for example, VGA signals, NTSC signals, PAL signals, digital television signals, composite video signals, S-video signals, RGBY video signals, uncompressed video signals, analog video signals, Digital Video Interface (DVI) signals (digital and/or analog), LVDS signals, etc. The processor-side encoder/decoders provide the video bitstreams to the transport layer. The transport layer provides the video bitstreams to the HID-side encoder-decoders 541-543. In one embodiment, the system operates with relatively low latency such that a user playing a video game on the processors 511-514 does not experience objectionable latency between inputs to the HID devices 551-552 and action on a video screen. In one embodiment, different serial bitstreams on the transport layer 531 are separated by time division multiplexing. In one embodiment, different serial bitstreams on the transport layer 531 are separated by time division multiplexing, frequency division multiplexing, orthogonal frequency division multiplexing, code division multiplexing, etc.

The system 500 routes signals between the processing units and the HIDs such that the users perceive that the HID devices 551-553 are directly connected to the corresponding processing units in the processor layer 510. As shown in FIG. 5, the HID network can be described in terms of five layers. The processor layer 510 contains the processing units. The processor-side HID encoder/decoder layer 520 contains processor-side encoder/decoders devices that link the processing units to the optical transport system. The transport layer 530 includes an optical shared media transport layer that connects the processing unit HID encoder/decoder layer 520 to the HID encoder/decoder layer 540. The HID encoder/decoder layer 540 contains devices that link the HIDs to the HID devices in the HID layer 550.

PU-optical linking devices in the processing unit HID encoder/decoder layer 520 convert native HID interface signals coming from one or more processing units into optical signals suitable for transport over the optical network system 531. In one embodiment, processing unit HID encoder/decoder layer 520 convert native HID analog and/or digital interface signals coming from one or more processing units into optical signals suitable for transport over the optical network system 531. The devices 521-524 in this layer also receive optical signals from the optical network system 531 and convert them into native HID interface signals for driving their corresponding processing units 511-514. Additional functionality can be embedded in this layer to provide KVM-type switching functionality (both electronic and opto-electronic), failover functionality (both electronic and opto-electronic), and optical network control functionality.

The HID-side encoder/decoders 541-543 in the fourth layer convert native HID interface signals coming from HID devices into optical signals suitable for transport over the optical network system 531. The HID encoder/decoders 541-543 also receive optical signals from the optical network system 531 and convert them into native HID interface signals for driving the HID devices. Additional functionality can be embedded in this layer to provide KVM-type switching functionality (both electronic and opto-electronic), failover functionality (both electronic and opto-electronic), and optical network control functionality.

The optical transport network layer 531 includes the physical media used to implement the transport network, such as for example, optical fiber, and the optical interfaces into the optical transport network. In one embodiment, there is one optical interface device (or set of devices) per encoder/decoder 521-524 and encoder/decoder 541-543. Therefore, these devices may be physically separate from the encoder/decoders 521-524 and encoder/decoders 541-543 or they can be packaged with the encoder/decoder 521-524 and encoder/decoder 541-543. Conflicts between the various optical signals on the shared optical fiber network are avoided by using shared media multiple access techniques such as time division multiple access (TDMA), wave division multiple access (WDMA), and combinations of TDMA and WDMA techniques. Many types of all optical networks can be used to implement the optical transport network in this system, including but not limited to passive optical networks (PON), with or without amplification, optical bus networks, and ring networks.

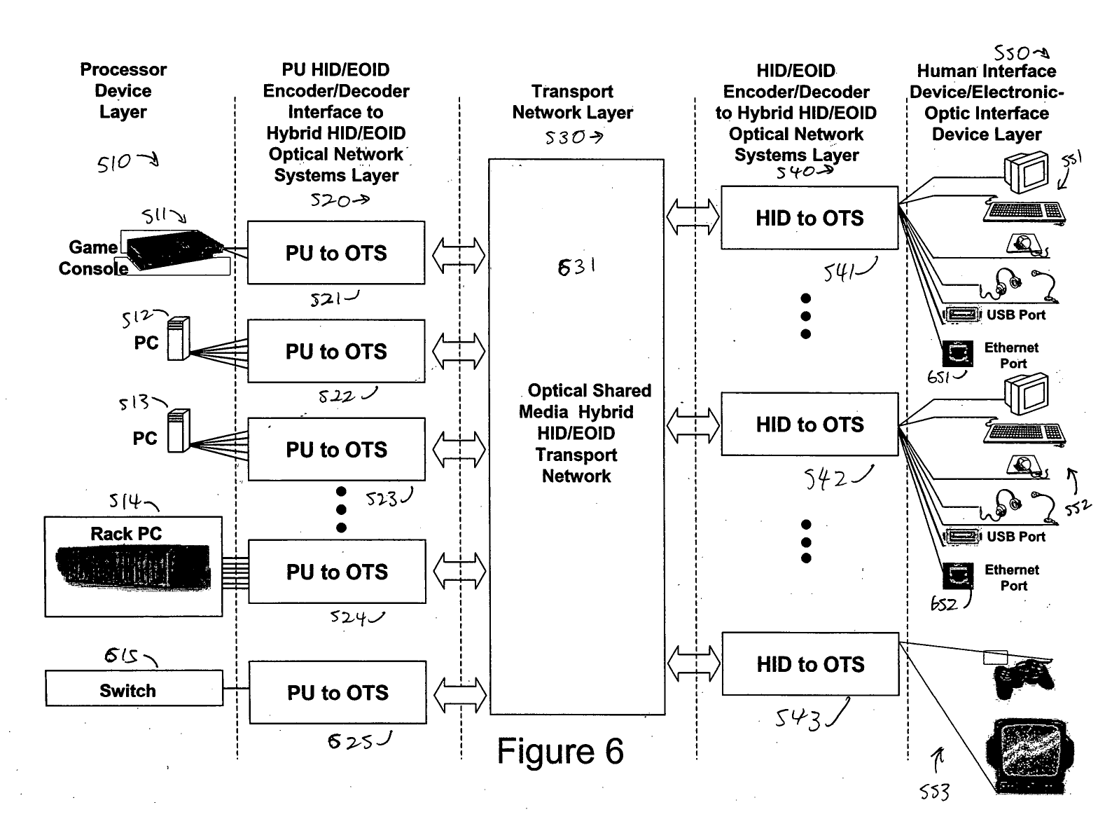

FIG. 6 shows a hybrid HID/electrical-optical interface device (HID/EOID) network 600 for connecting a plurality of processing units that can be either co-located (such as in a PC rack), or distributed, to a plurality of distributed groupings of human interface devices, electrical interface devices, and optical interface devices through an all optical shared media transport network such that the network is transparent with respect to a user using the remote HID devices and the remote EOID devices are functional.

The system 600 is similar to the system 500. The system 600 includes a network switch 615 provided to a processor-side encoder/decoder 625. One or more network ports (e.g., network ports 651, 652) are provided in the HID layer 550.

In many applications, it is desirable to have both remote HID devices as well as remote EOID devices. For example, PCs typically have serial ports and USB ports that remote users may want to access. These ports can support both HIDs and non-HIDs. In addition, remote users may also want access to a standard data network for networking a remote PC such as a laptop. This hybrid HID/EOID system provides a network for remoting both HID device interfaces as well as non HID device interfaces such as serial ports, USB ports, and standard data network ports (Ethernet). Thus, the system 600 routes data and other network signals between the network switch 615 and the network ports 651-652 to provide network access at the network ports 651-652. The network switch 615 can include, for example, a serial network switch, an Ethernet switch, a firewire switch, a USB switch, a fibre-channel switch, etc.

The networks 500/600 described herein can be used in office applications. In an office application, the primary processing units in the processor layer 510/610 are typically PCs in racks at a central location to lower acquisition, maintenance, and upgrade costs while providing business owners a more secure computing system. Typical deployments of these networks in office applications will have one interface into the optical network for each desk/user or local group of desks/users. For example, a multi-user office may have one interface for the entire office or one for each desk in the office.

The networks 500/600 described herein can be used in hospitality applications. In a typical hospitality application, the processing units in the processor layer 510/610 include are set top boxes, game consoles, and PCs which are in racks at a central location to lower acquisition, maintenance, and upgrade costs while providing a more secure content distribution system. These systems may also provide remote access to a centrally located data network (Ethernet) switch. Hospitality applications include, for example, hotels, motels, cruise ships, and hospitals. Typical deployments of these networks in hospitality applications will have one interface into the optical network for each room or local group of rooms which may be part of the same suite.

The networks 500/600 described herein can also be used in dense seat applications with personal displays, such as, for example, busses, in-flight entertainment systems for aircraft, entertainment systems for trains, entertainment systems for buses, entertainment systems for theaters, and entertainment systems for arenas/stadiums/airports, etc. In a typical dense seat application, the primary processing units in the processor layer 510/610 include are set top boxes, game consoles, streaming video sources, and PCs, which are typically in racks at a central location to lower acquisition, maintenance, and upgrade costs while providing a more secure content distribution system. These systems can also provide remote access to a centrally located data network (Ethernet) switch. Typical deployments of these networks in dense seat applications will have one interface into the optical network for each seat or local group of seats (seat group). To simplify remote wiring, the HID/EOID's corresponding to a given seat can be distributed across two or more optical network interfaces. For example, the HID/EOIDs that are mounted in the arm rest of the passenger/user can be routed through the optical interface associated with that passenger/user's seat or seat group whereas the HID EOIDs that are mounted in the seat back of the seat in front of the passenger/user can be routed through the passenger/user's seat or seat group associated with that seat back.

The networks 500/600 can also be used in connection with content providers to the home, office, apartment, store, etc. In a typical content provider application, the primary processing units in the processor layer 510/610 are typically set top boxes, game consoles, and PC's which are typically provided in racks at a central location to lower acquisition, maintenance, and upgrade costs while providing a more secure content distribution system. These systems can also provide remote access to a centrally located data network (Ethernet) switch. Content providers to the home include, for example, cable companies and other broadband providers. Typical deployments of these networks in this application will have one or more interfaces into the optical network for each home or apartment unit depending on the number of independent displays to be supported.

In one embodiment, HID signals from the processing units in the processing layer 510 are sampled by the encoders/decoders 520-524 and 625 in the encoder/decoder layer 520 at frequencies above the Nyquist rate, such that the HID signals can be provided to the HID layer 540 and reconstructed by the HID encoder/decoders 541-543. In one embodiment, in the downstream path, the encoders/decoders 520-524 and 625 perform analog sampling and analog-to-digital conversion of the HID signals from the processing units 511-514 and 615 and the encoder/decoders 541-543 provide digital-to-analog conversion. In this manner, the raw HID signals can be provided from the processing units 521-513 and 625 to the HID devices in the HID layer 550. Similarly, in the upstream path, the HID encoders/decoders 5541-543 perform analog sampling and analog-to-digital conversion of the HID signals from the HIDs in the HID layer 550 and the encoder/decoders 521-523 provide digital-to-analog conversion. In this manner, the raw HID signals can be provided from the HID groups 551-553 to the processor devices in the processor layer 510.

In one embodiment, the network system 500/600 provide a logical connection between one of the encoder/decoders 521-524 and one of the HID encoder/decoders 541-543. Thus, for example, the network system 500/600 can establish a logical connection between the PC 512 and any one of the HID groups 551-553. In one embodiment, the logical connection between one of the encoder/decoders 521-524 and one of the HID encoder/decoders 541-543 is established dynamically, such that the processing units can be allocated to the HID groups 551-554. This allows use of the processing units to be allocated to the HID groups 551-553 in circumstances where there are more HID groups 551 than processing units. Thus, for example, in an airline in-flight entertainment system, an HID group can be provided to each seat but the system need not provide a processing unit for each seat, since all passengers will likely not want to use the processing units at the same time.

In one embodiment, the transport network layer provides a “broadcast” mode wherein one of the processing units in the processor layer 510 can be provided to all of the HIDs in the HID layer. The broadcast mode can be used, for example, to provide preflight safety instructions, broadcast an in-flight movie, etc.

The logical connection between the processor units 521-524 and the HID groups 551-553 can be provided by dynamic techniques, such as, for example addressing packets on a network, selecting a slot in a time division multiplexing system etc. Alternatively, a logical connection between the processor units 521-524 and the HID groups 551-553 can be provided by assigning a time (and or frequency) slot to each HID group unit and using a crossbar switch to make a logical connection between a selected HID group and a selected processing unit.

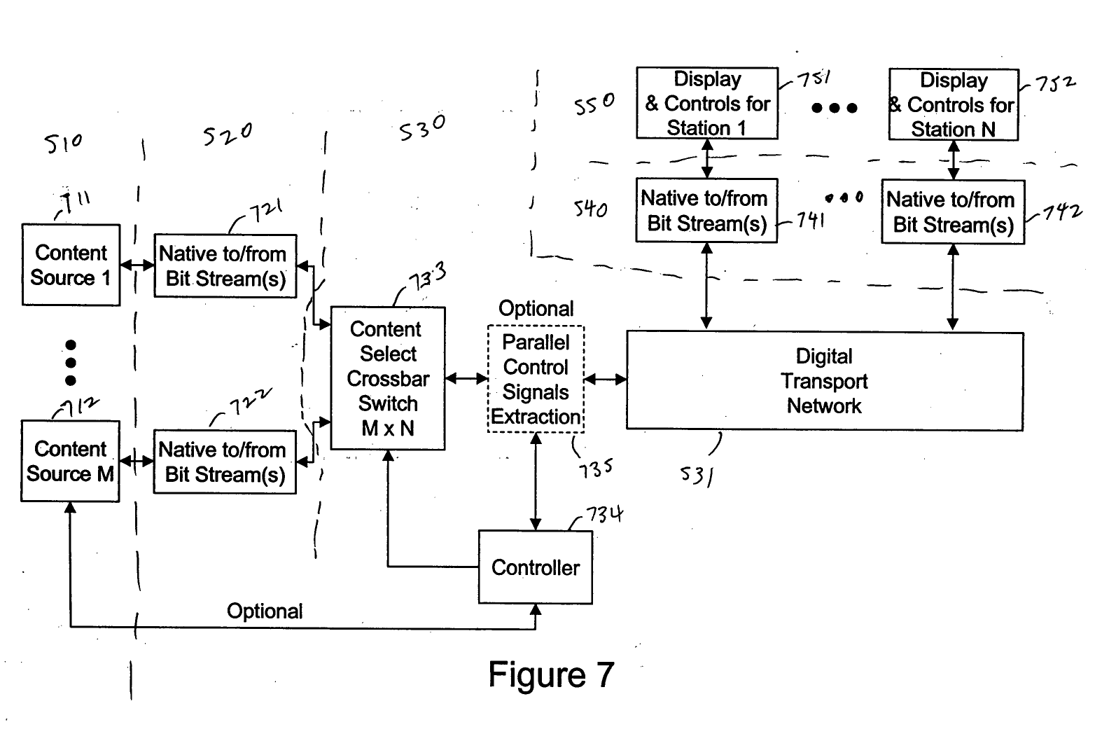

FIG. 7 shows one embodiment of the networks 500/600 wherein a crossbar switch is provided in the transport layer to facilitate logical connections between devices in the processor layer 510 and the HID layer 550. The processor layer 510 includes one or more processing units, such as, for example, game consoles, streaming audio and/or video sources 711, 712, video or audio on demand sources, communication devices (e.g., telephone devices), global position system devices, flight information devices, one or more computers, and/or any device that provides analog and/or digital data signal to an HID or that receives analog and/or digital signals.

The processing unit HID encoder/decoder layer 520 includes processing unit HID encoder/decoders 721-722. The processing unit HID encoder/decoder 721 is provided to encode/decode HID data and/or signals for the source 711. The processing unit HID encoder/decoder 722 is provided to encode/decode HID data and/or signals for the source 712. The transport layer 530 includes the optical shared network 531 an M×N crossbar switch 733 and a controller 734. The processing unit HID encoder/decoders 721-722 are provided to the M×N crossbar switch 733. N outputs from the crossbar switch 733 are provided to the optical shared network 531. In one embodiment, an optional parallel control signal extraction block 733 is provided between the crossbar 733 and the transport network 531. The HID encoder/decoder layer 540 includes one or more HID encoders, such as, for example HID encoders 741-742. The HID encoders are provided to HID devices in the HID layer 550, such as, for example, HID groups 751-752. The HID groups 751-752 include one or more HID devices, such as, for example, keyboards, computer mice, video display units, game controllers, joysticks, microphones, speakers, keypads, printers, scanners, etc.

The crossbar 733 conveniently allow M processing units in the processing layer 510 to be provided to N HID groups in the HID layer 550. In one embodiment, the crossbar 733 is fully populated, such that any of M processing units in the processing layer 510 can be logically connected to any of the N HID groups in the HID layer 550. As described above, the use of a crossbar switch means that the logical “position” (e.g., position in time, space, and/or frequency) of the HID groups on the network can be fixed and need not be dynamically programmable. Allowing the logical network position of the HID groups to be fixed typically simplifies the construction and reduces cost and complexity of the HID encoders/decoders 541-543. Allowing the logical network position of the HID groups to be fixed also reduces network overhead and thus improves throughput of the transport layer 530.

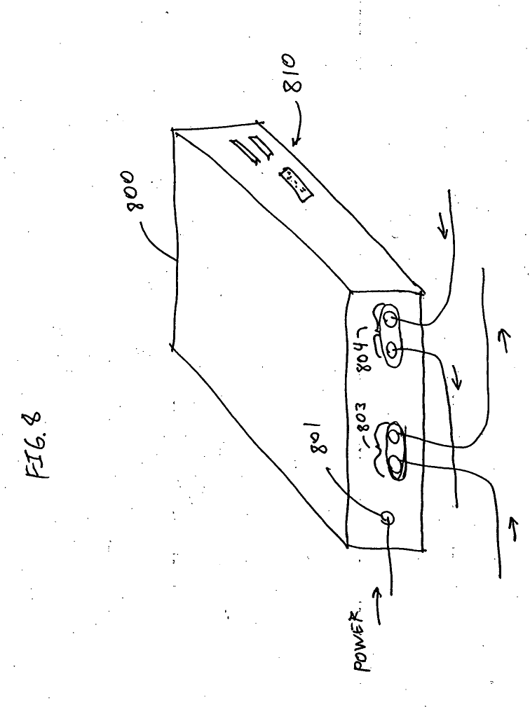

FIG. 8 shows one embodiment of an HID encoder/decoder 800 for use in the remote device networks 500, 600, 700. The HID encoder/decoder 800 is one embodiment of the HID encoder/decoders 541-543 and/or 741-742. The HID encoder/decoder includes one or more connector ports 810 for connecting to human interface devices, such as, for example, computer mice, game controllers, keyboards, displays, computer network ports, USB ports, firewire ports, etc. The HID encoder/decoder 800 includes a power input 801, a first network data input/output 803 for a first link path, and a second network data input/output 804 for a second link path. In one embodiment, the first and second network data input/outputs 803 804 are configured as optical connectors for a first fiberoptic cable path and a second fiberoptic cable path respectively. In one embodiment, two link paths are provide to provide redundancy (as it typical in networks such as, for example, token-ring networks, fibre-channel networks, etc.) so that if one link path fails the HID encoder/decoder is still able to communication. In one embodiment, the first and second link paths are provided for upstream and down stream communications. In one embodiment, each link path is bi-directional. In one embodiment, the input/outputs 803, 804 are configured for multi-mode fiberoptic fibers. In one embodiment, the input/outputs 803, 804 are configured for single-mode fiberoptic fibers. In one embodiment, the input/outputs 803, 804 are configured for coaxial cable. In one embodiment, the input/outputs 803, 804 are configured for twisted-pair wiring. In one embodiment, the HID encoder/decoder is a relatively compact, relatively low-power device,

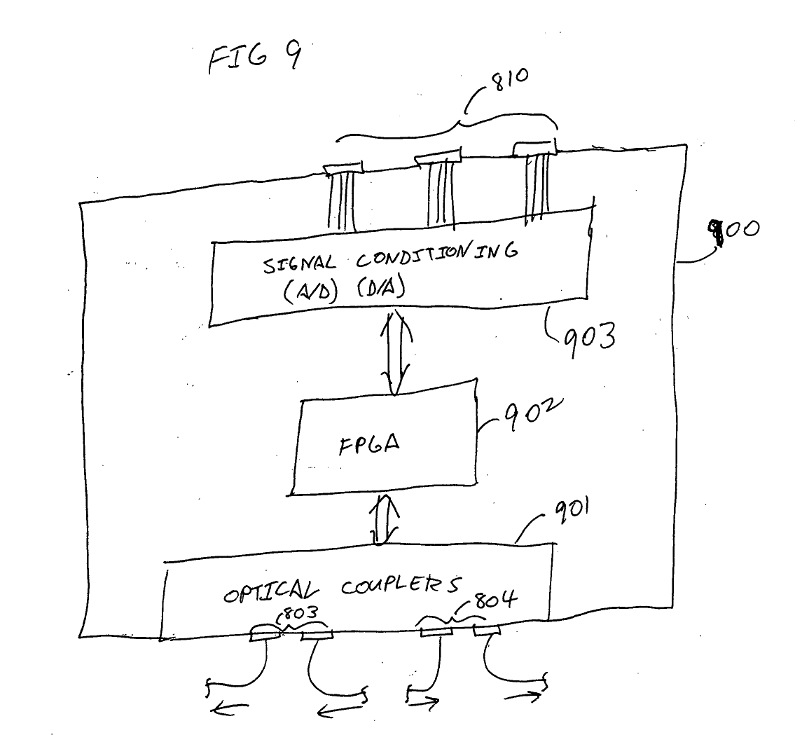

FIG. 9 is a block diagram 900 of one embodiment of the HID encoder/decoder 800 for use in an optical network. In the block diagram 900, the input/output ports 803 and 804 are provided to an optical coupling and switching module 901. The optical coupling and switching module 901 is provided to a processor module (e.g., an FPGA module) 902. The processor module 902 is provided to a signal conditioning module 903. The signal conditioning module 902 provides analog signal conditioning such as, for example, analog-to-digital conversion, digital-to-analog conversion, level shifting, output drivers. Analog signals from the signal conditioning module are provided to the HID connector ports 810. In a non-optical network, the optical coupling and switching module 901 is replaced with a radio-frequency coupling and switching network.

The processor module 902 receives data from the optical coupler module 901 and de-serializes and formats the data, and provides the digital data to the signal conditioning module 903. Similarly, the processor module 902 receives digital data from the signal conditioning module 903, formats and serializes the data, and provides the serialized data to the optical coupling module 901. The high data rates provided by fiber-optic cable allows the processor-side encoder/decoders in the layer 520 to provide direct sampling of audio and video streams, and allows the transport layer 530 to carry multiple such direct-sampled video streams to multiple HID encoder/decoders 900. In one embodiment, the streams for different HID encoder/decoders 900 on the same fibre can be separated by time-division multiplexing.

Although described in terms of an optical network, the system described herein can be constructed using other network transport systems, such as, for example, coaxial cable, twisted pair cable, wireless, and/or combinations thereof with or without optical cable.

Although the preceding description contains much specificity, this should not be construed as limiting the scope of the invention, but as merely providing illustrations of embodiments thereof. Accordingly, the scope of the invention is limited only by the claims.

1. A remote device interface network, comprising:
a first processing unit configured to provide at least a first raw video output signal for a first video display;
a second processing unit configured to provide at least a second raw video output signal for a second video display;
a first processor-side encoder/decoder configured to convert said first raw video output signal into a first serial digital sampled data stream;
a second processor-side encoder/decoder configured to convert said second raw video output signal into a second serial digital sampled data stream;
a first HID-side encoder/decoder configured to convert said first serial digital sampled data stream into a representation of said first raw video output signal;
a second HID-side encoder/decoder configured to convert said second serial digital sampled data stream into a representation of said second raw video output signal and to convert signals from an output signal from a human interface device into a third serial digital sampled data stream; and
a shared-media transport layer configured to provide bi-directional communication between said first and second processor-side encoder/decoders and said first and second HID-side encoder/decoders by transporting said first and second serial digital sampled data streams in a downstream direction and transporting said third serial digital sampled data stream in an upstream direction.

2. The remote device interface network of claim 1, wherein said transport layer comprises a fiberoptic system.

3. The remote device interface network of claim 1, wherein said transport layer comprises single-mode fiber.

4. The remote device interface network of claim 1, wherein said transport layer comprises coaxial cable.

5. The remote device interface network of claim 1, wherein said transport layer comprises twisted-pair cable.

6. The remote device interface network of claim 1, wherein said first raw video output signal comprises a VGA video signal.

7. The remote device interface network of claim 1, wherein said first raw video output signal comprises an NTSC video signal.

8. The remote device interface network of claim 1, wherein said first raw video output signal comprises a PAL video signal.

9. The remote device interface network of claim 1, wherein said first raw video output signal comprises a digital television signal.

10. The remote device interface network of claim 1, wherein said first raw video output signal comprises a composite video signal.

11. The remote device interface network of claim 1, wherein said first raw video output signal comprises an S-video signal.

12. The remote device interface network of claim 1, wherein said first raw video output signal comprises a RGBY video signal.

13. The remote device interface network of claim 1, wherein said first raw video output signal comprises an uncompressed video signal.

14. The remote device interface network of claim 1, wherein said first raw video output signal comprises a DVI video signal.

15. The remote device interface network of claim 1, wherein said first raw video output signal comprises a DVI-analog video signal.

16. The remote device interface network of claim 1, wherein said first raw video output signal comprises a DVI-digital video signal.

17. The remote device interface network of claim 1, wherein said first raw video output signal comprises a LVDS video signal.

18. The remote device interface network of claim 1, wherein said output signal from a human interface device comprises a USB signal.

19. The remote device interface network of claim 1, wherein said output signal from a human interface device comprises an Ethernet-compatible waveform.

20. The remote device interface network of claim 1, wherein said output signal from a human interface device comprises a firewire compatible waveform.

21. The remote device interface network of claim 1, wherein said output signal from a human interface device comprises a standard serial computer mouse signal.

22. The remote device interface network of claim 1, wherein said output signal from a human interface device comprises a standard personal computer keyboard signal.

23. The remote device interface network of claim 1, wherein said output signal from a human interface device comprises a game controller signal.

24. The remote device interface network of claim 1, wherein said transport network comprises a crossbar configured to provide bi-directional communication between M processor-side encoder/decoders and N HID-side encoder/decoders.

25. The remote device interface network of claim 1, wherein a latency delay between an input of said first processor-side encoder/decoder and an output of said first HID-side encoder/decoder is less than five video frames of said first raw video signal.

26. The remote device interface network of claim 1, wherein a latency delay between an input of said first processor-side encoder/decoder and an output of said first HID-side encoder/decoder is less than two video frames of said first raw video signal.

27. A remote device interface network, comprising:
a first processing unit configured to provide at least a first native video output signal for a first video display;
a second processing unit configured to provide at least a second native video output signal for a second video display;
a first processor-side encoder/decoder configured to convert said first native video output signal into a first serial digital sampled data stream;
a second processor-side encoder/decoder configured to convert said second native video output signal into a second serial digital sampled data stream;
a first HID-side encoder/decoder configured to convert said first serial digital sampled data stream into a representation of said first native video output signal;
a second HID-side encoder/decoder configured to convert said second serial digital sampled data stream into a representation of said second native video output signal and to convert signals from an output signal from a human interface device into a third serial digital sampled data stream; and
a shared-media transport layer configured to provide bi-directional communication between said first and second processor-side encoder/decoders and said first and second HID-side encoder/decoders by transporting said first and second serial digital sampled data streams in a downstream direction and transporting said third serial digital sampled data stream in an upstream direction.

28. The remote device interface network of claim 27, wherein said transport layer comprises a fiberoptic system.

29. The remote device interface network of claim 27, wherein said transport layer comprises single-mode fiber.

30. The remote device interface network of claim 27, wherein said transport layer comprises coaxial cable.

31. The remote device interface network of claim 27, wherein said transport layer comprises twisted-pair cable.

32. The remote device interface network of claim 27, wherein said first native video output signal comprises a VGA video signal.

33. The remote device interface network of claim 27, wherein said first native video output signal comprises an NTSC video signal.

34. The remote device interface network of claim 27, wherein said first native video output signal comprises a PAL video signal.

35. The remote device interface network of claim 27, wherein said first native video output signal comprises a digital television signal.

36. The remote device interface network of claim 27, wherein said first native video output signal comprises a composite video signal.

37. The remote device interface network of claim 27, wherein said first native video output signal comprises an S-video signal.

38. The remote device interface network of claim 27, wherein said first native video output signal comprises a RGBY video signal.

39. The remote device interface network of claim 27, wherein said first native video output signal comprises an uncompressed video signal.

40. The remote device interface network of claim 27, wherein said first native video output signal comprises a DVI video signal.

41. The remote device interface network of claim 27, wherein said first native video output signal comprises a DVI-analog video signal.

42. The remote device interface network of claim 27, wherein said first native video output signal comprises a DVI-digital video signal.

43. The remote device interface network of claim 27, wherein said first native video output signal comprises a LVDS video signal.

44. The remote device interface network of claim 27, wherein said output signal from a human interface device comprises a USB signal.

45. The remote device interface network of claim 27, wherein said output signal from a human interface device comprises an Ethernet-compatible waveform.

46. The remote device interface network of claim 27, wherein said output signal from a human interface device comprises a firewire compatible waveform.

47. The remote device interface network of claim 27, wherein said output signal from a human interface device comprises a standard serial computer mouse signal.

48. The remote device interface network of claim 27, wherein said output signal from a human interface device comprises a standard personal computer keyboard signal.

49. The remote device interface network of claim 27, wherein said output signal from a human interface device comprises a game controller signal.

50. The remote device interface network of claim 27, wherein said transport network comprises a crossbar configured to provide bi-directional communication between M processor-side encoder/decoders and N HID-side encoder/decoders.

51. The remote device interface network of claim 27, wherein a latency delay between an input of said first processor-side encoder/decoder and an output of said first HID-side encoder/decoder is less than five video frames of said first native video signal.

52. The remote device interface network of claim 27, wherein a latency delay between an input of said first processor-side encoder/decoder and an output of said first HID-side encoder/decoder is less than two video frames of said first native video signal.

53. The remote device interface network of claim 27, wherein said second processor-side encoder/decoder is further configured to receive a second signal for said human interface device and to serialize said second signal for said human interface device.
